(19) United States
(12) Patent Application Publication
(10) Pub. No.: US 2007/0036285 A1
(43) Pub. Date: Feb. 15, 2007

(54) Charm alarm

(76) Inventor: Barbara Noreen Pillsbury, Escondido, CA (US)

Correspondence Address: BARBARA N. PILLSBURY, 1029 INSPIRATION LANE, ESCONDIDO, CA, 92025, US

(21) Appl. No.: 11/198,853

(22) Filed: Aug. 8, 2005

(51) Int. Cl. H04M 1/64

(52) U.S. Cl. 379/67.1

(57) ABSTRACT

By utilizing current available technology found in telephone answering machine recording devices, my invention, the Charm Alarm recording concept in an alarm clock will make an effective, positive use of existing technology that will enable people to choose and create their own “best method” of awaking. At a pre-set time, the alarm clock would begin the recorded message that will gently and peacefully awaken the listener. Therefore by recording meaningful thoughts, loving messages, inspirational insights into this special alarm clock, with the Charm Alarm concept and hearing these words upon waking, will result in a healthier alternative when being brought out of a restful sleep.

### CROSS-REFERENCE TO RELATED APPLICATIONS

NA

### STATEMENT REGARDING FEDERALLY SPONSORED RESEARCH/DEVELOPMENT

NA

### REFERENCE TO SEQUENCE LISTING, A TABLE, OR A COMPUTER PROGRAM, ETC.

NA

### BACKGROUND OF THE INVENTION

Having tried various methods to awaken daily, it occurred to me, there must be a better way to start the day than listening to the screaming of an alarm clock. This contributed to stress and caused sleep to be distressful, knowing that is the first thing I will hear in the morning. There are a number of methods on the market including blasters, sonic boom sounds, bed shakers, vibrators, celebrity voices and other pre-recorded sounds that may wake you up, but not pleasantly.

### BRIEF SUMMARY OF THE INVENTION

My invention called the Charm Alarm is a better way to start the day. By utilizing a recording device, such as the kind found in telephone answering machines, conceptually inserted into an alarm clock, enabling you to record your own loving, inspiring, motivational and encouraging messages as a healthier way to waken.

### BRIEF DESCRIPTION OF THE SEVERAL VIEWS OF THE DRAWING

NA

### DETAILED DESCRIPTION OF THE INVENTION

Alarm clocks and the devices that are currently in the retail marketplace to assist you in waking up may be contributing to stress related problems. It truly is “alarming” to be awakened by a device that screams at you or shakes your bed. My invention, the Charm Alarm, would eliminate the need for artificial and manufactured sounds and the drastic measures currently utilized; but would instead create a pleasant and peaceful way to start your day.

The technology of the recording device of a telephone answering machine would work in the same manner within the alarm clock. A telephone answering machine recording is activated after a certain number of rings, then a recorded message is heard. The Charm Alarm recording concept would be heard when the alarm clock is set at a pre-selected time to awaken you. The recorded message can be set to be repeated. You can change a message as needed or record a loved one's voice with a loving message to wake up to. You can record words of motivation, inspiration, encouragement or favorite poems. This concept could even assist in the learning process of a foreign language or other studies. Imagine how gratifying it would be to hear your child's voice wake you up, on your travel Charm Alarm, when you are away on business. The choice would be yours . . . what are the words you would like to wake up to?

The old alarm clock methods to wake up to are artificial, manufactured, annoying and stressful. Replacement alternative is with a personal, positive and inspiring new method with the Charm Alarm recording concept system.

This method of awakening will result in a healthier alternative and will be beneficial to our attitudes and outlooks for each day by hearing words of love, inspiration, motivation and encouragement spoken by a loved one or in your own voice, words that you can choose and change. Create your own messages of motivation.

1. Wake up to your own or a loved one's recorded words with the Charm Alarm method.

2. Less stressful method to start your day with your chosen words of love, inspiration, motivation.

3. Utilizing current technology in a new, improved and more useful manner.

4. Can be used as a reminder of important events.

5. Effective, positive tool to awaken school age children.

6. Assist in the learning or memorizing process of studies and languages.
